(19) United States
(12) Patent Application Publication
(10) Pub. No.: US 2015/0274424 A1
(43) Pub. Date: Oct. 1, 2015

(54) Subterranean Fluid Storage Configurations and Methods

(71) Applicant: NEP IP, LLC, Sheridan, WY (US)

(72) Inventors: Joseph McPhie, Ranchester, WY (US); Robert Ferri, Cody, WY (US); Jason Todd, Ranchester, WY (US); Joshua Walton, Sheridan, WY (US)

(21) Appl. No.: 14/226,552

(22) Filed: Mar. 26, 2014

(51) Int. Cl. B65G 5/00; E21D 13/00; E21D 9/14

(52) U.S. Cl. CPC B65G 5/00; E21D 9/14; E21D 13/00

(57) ABSTRACT

Subterranean tunnel and storage configurations are provided that can include: a first vertical tunnel extending from the terrain above the configuration and through the earth below; a subterranean room connecting with the first vertical tunnel; a second vertical tunnel connecting with the subterranean room and aligned with the first vertical tunnel; and a fluid storage assembly below the subterranean room and within the vertical tunnel, the assembly comprising one or more fluid storage tanks. Subterranean tunnel and storage configurations are also provided that can include: a subterranean room within the earth below the terrain; a vertical tunnel connecting with the subterranean room and extending into the earth below the subterranean room; and a fluid storage assembly within the second vertical tunnel. Methods for providing and/or removing fluid storage from a subterranean petroleum mining configurations are provided. The methods can include: providing one or more fluid storage tanks; and conveying the one or more fluid storage tanks in a continuous vertical direction between the terrain above the configuration to a tunnel below a subterranean room of the configuration.

### TECHNICAL FIELD

The present disclosure relates generally to the acquisition of fluids from underground mining sites, including subterranean rooms. In particular embodiments, the present disclosure relates to subterranean fluid storage configurations as well as methods.

### BACKGROUND

Recently, it has become feasible to acquire petroleum products such as natural gas and crude oil products from subterranean rooms. As part of acquiring these fluids from these rooms, challenges are presented that include the storage of fluids that are acquired or needed during the acquisition process. These subterranean rooms can be difficult to manipulate and/or store fluids in, thereby making the acquisition of the fluids and the storage thereof difficult. The present disclosure provides subterranean fluid storage assemblies and methods.

### SUMMARY OF THE DISCLOSURE

Subterranean tunnel and storage configurations are provided that can include: a first vertical tunnel extending from the terrain above the configuration and through the earth below; a subterranean room connecting with the first vertical tunnel; a second vertical tunnel connecting with the subterranean room and aligned with the first vertical tunnel; and a fluid storage assembly below the subterranean room and within the vertical tunnel, the assembly comprising one or more fluid storage tanks.

Subterranean tunnel and storage configurations are also provided that can include: a subterranean room within the earth below the terrain; a vertical tunnel connecting with the subterranean room and extending into the earth below the subterranean room; and a fluid storage assembly within the second vertical tunnel.

Methods for providing and/or removing fluid storage from subterranean petroleum mining configurations are provided. The methods can include: providing one or more fluid storage tanks; and conveying the one or more fluid storage tanks in a continuous vertical direction between the terrain above the configuration to a tunnel below a subterranean room of the configuration.

### DRAWINGS

Embodiments of the disclosure are described below with reference to the following accompanying drawings.

FIG. 1 is an example subterranean room and storage area configuration according to an embodiment of the disclosure.

FIG. 2 is another subterranean room and storage area configuration according to another embodiment of the disclosure.

FIG. 3 is a view of a portion of FIG. 2 according to an embodiment of the disclosure.

FIG. 4 is a view of another portion of FIG. 2 according to an embodiment of the disclosure.

FIG. 5 is another subterranean fluid storage configuration according to an embodiment of the disclosure.

FIG. 5A is a view of a portion of the configuration of FIG. 5 according to an embodiment of the disclosure.

FIG. 6 is yet another subterranean room configuration according to an embodiment of the disclosure.

FIG. 6A is a view of a portion of the configuration of FIG. 6 according to an embodiment of the disclosure.

FIG. 7 is another subterranean room and storage configuration according to an embodiment of the disclosure.

FIG. 8 is another subterranean room and storage configuration according to an embodiment of the disclosure.

FIG. 9 is yet another subterranean room and storage configuration according to an embodiment of the disclosure.

### DESCRIPTION

This disclosure is submitted in furtherance of the constitutional purposes of the U.S. Patent Laws “to promote the progress of science and useful arts” (Article 1, Section 8).

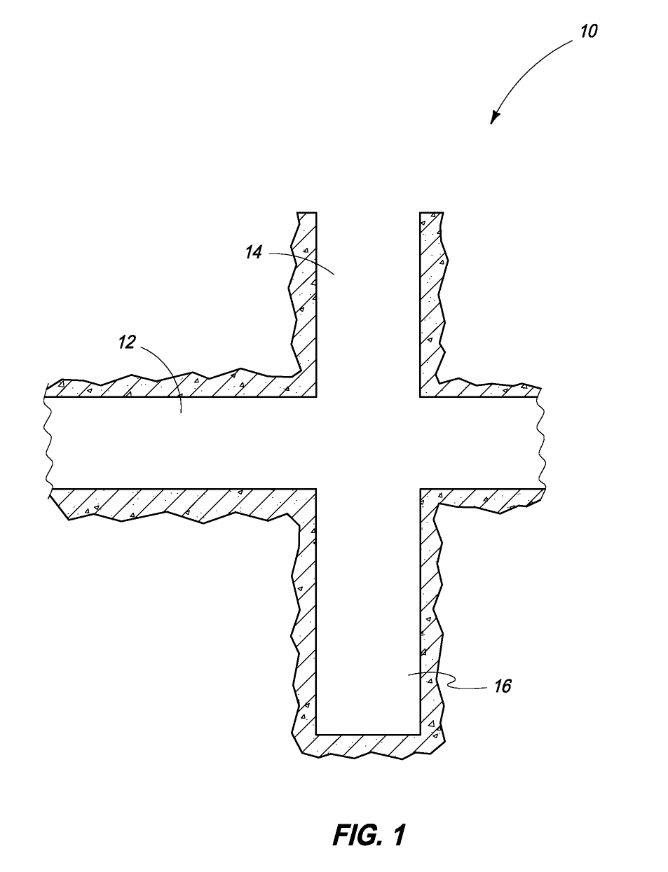

The present disclosure will be described with reference to FIGS. 1-9. Referring first to FIG. 1, FIG. 1 depicts a view of a subterranean room and storage configuration 10 in at least one cross section according to an embodiment of the disclosure. In accordance with this configuration, subterranean room 12, as a horizontal tunnel is in connection with both first vertical tunnel 14 and second vertical tunnel 16. It is contemplated that tunnel 14 will extend from the terrain above the configuration and through the earth below the terrain to room 12.

As can be seen, tunnel 16 can be aligned below tunnel 14. It is contemplated that items, such as fluid storage containers can be lowered from the terrain via tunnel 14 through room 12 and into tunnel 16. Tunnel 16 can be utilized to store and/or act as a fluid storage assembly.

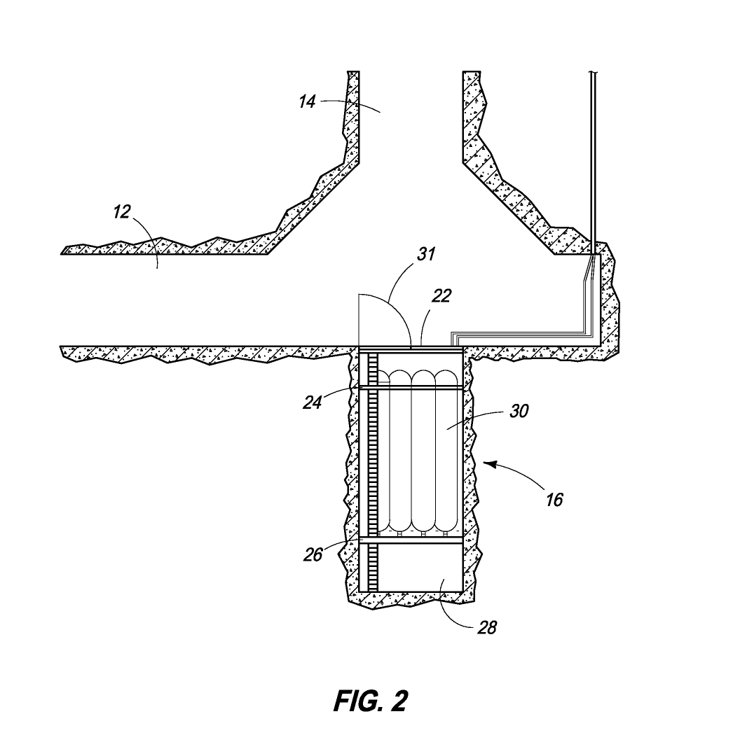

Referring to FIG. 2, in accordance with an example implementation, tunnel 16 can include one or more fluid storage tanks 30 that may have been transferred via tunnel 14 through room 12 to within tunnel 16. Tunnel 16 may include a series of decks or platforms such as partitions 22, 24, and 26, some or all of which may include a passageway such as passageway 31.

In accordance with an example implementation, a flooring platform 22 may be provided extending between the sidewalls or edges of tunnel 16 that may be configured to allow for the maintenance and/or providing of additional storage tanks within tunnel 16. This platform 22 may be commensurate in elevation with the floor of subterranean room 12, for example.

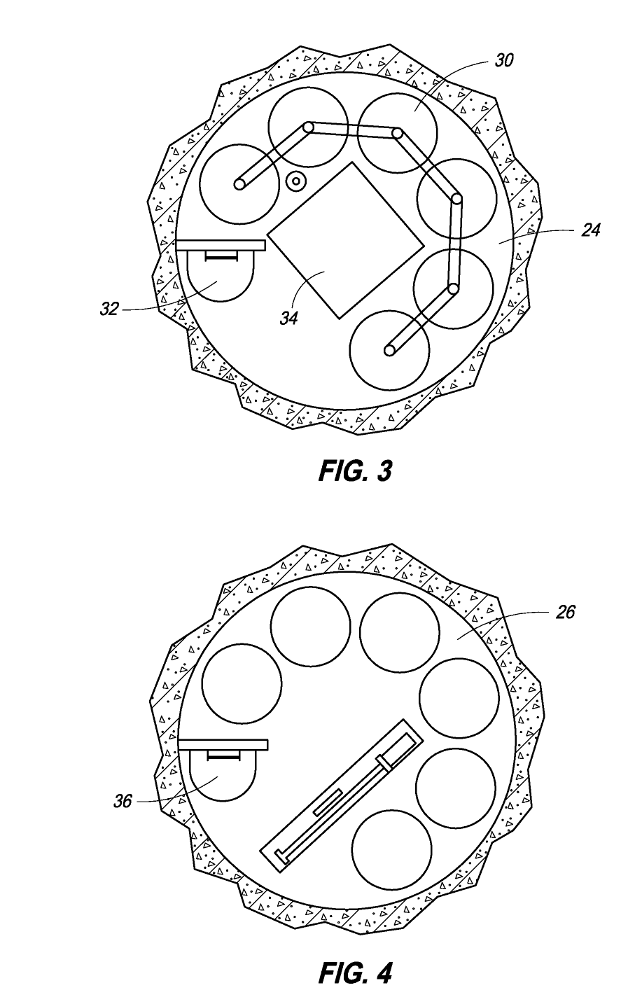

In accordance with another embodiment of the disclosure, an additional platform 24 may be provided. This platform can allow for access to the top or upper portions of tanks within tunnel 16 and is shown in more detail in FIG. 3. Referring next to FIG. 3, an upper view of platform 24 is shown that includes a series of tanks 30 in a perimeter configuration engaged about the perimeter of tunnel 16. Accordingly, a ladder access point 32 is shown proximate a center maintenance hatch 34.

Still another platform 26 may be provided that is below platform 24 and below platform 22 and is shown in more detail in FIG. 4. Platform 26 may define an additional space 28 defined by platform 26 and sidewalls and floor of tunnel 16, which may be considered a subspace 28. Platform 26 can provide for the support of tanks within tunnel 16 above subspace 28, for example. Subspace 28 may be utilized as a sump to catch spills that have accumulated or may accumulate upon a release of fluids from one or more of the tanks stored above the tank platform 26.

The present disclosure contemplates a plurality of individual tanks as well as a single tank. In accordance with example implementations, when provided as a plurality, the tanks may include a 4 foot diameter, 20 foot tall, 45-barrel pressure rated tank, for example. These tanks may be aligned along the perimeter of tunnel 16, for example. From platform 26 to platform 22, a height of approximately 20′ is envisioned, whereas a height from the base of tunnel 16 to platform 26 of 8′ is envisioned. In accordance with example implementations, tunnel 16 may have venting or piping extending therefrom to allow for the venting or removal of fluids from tunnel 16.

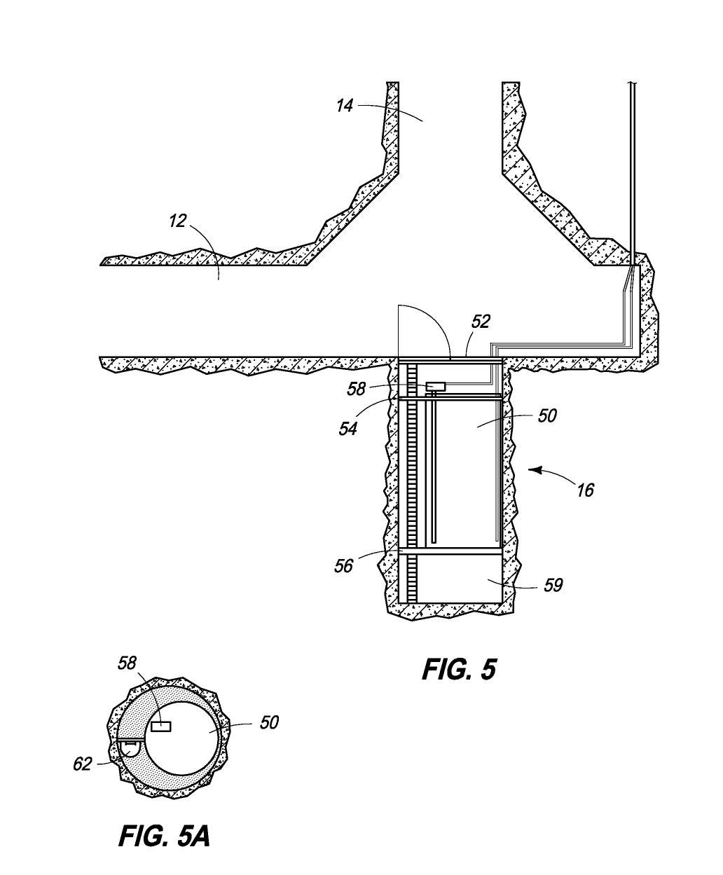

Referring to FIGS. 5 and 5A and, in accordance with another implementation of the present disclosure, a single tank such as a 500-barrel steel tank 50 can exist within tunnel 16. In accordance with example implementations, partitions 52, 54 and 56 can be configured as platforms. Tank 50 may be equipped with an impeller pump such as an impeller pump 58 to facilitate the removal of fluid from within tank 50. The impeller pump may be a top drive 480 volt submerged impeller pump, for example. Tank 50 may also include a gas vent line as previously described in previous configurations. This gas vent line may be a 3″ gas vent line and level monitoring standpipe, for example. Tunnel 16 of FIG. 5 may be equipped as well with a ladder access point 62 that extends through platforms 52, 54, and 56 to sump area 59.

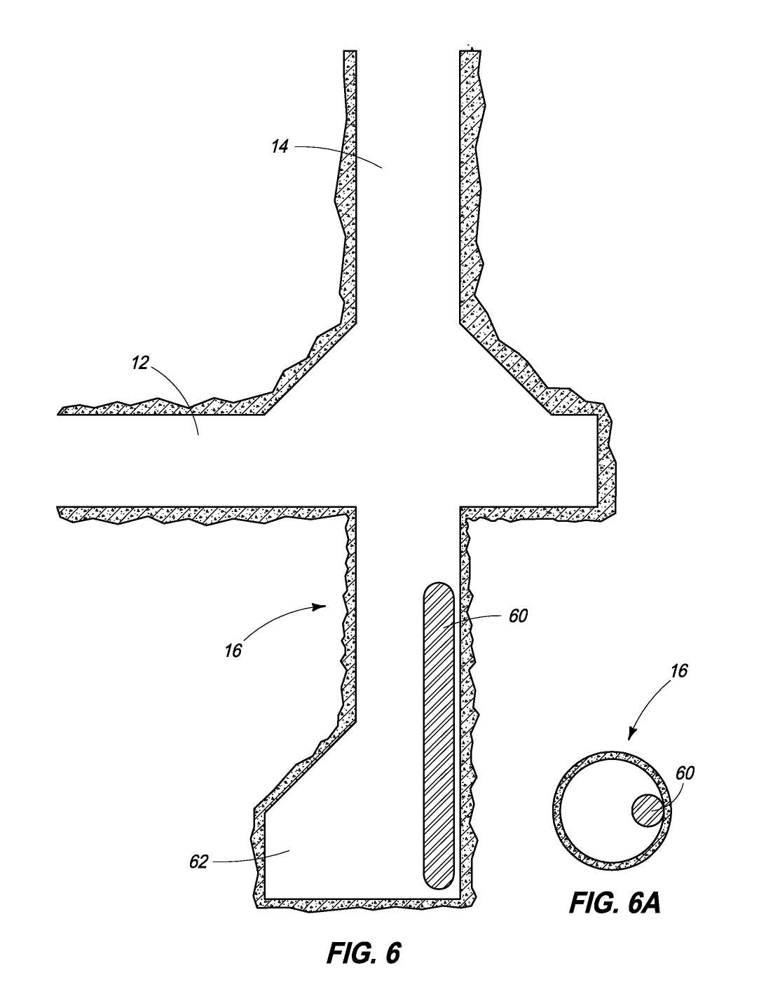

Referring to FIG. 6, in accordance with another embodiment of the disclosure, a fluid storage assembly such as a tank 60 may be provided to within tunnel 16. Tank 60 may be rated as described previously. In accordance with example implementations, tunnel 16 may further include a bulkhead 62 which extends outward from the perimeter established by tunnel 16. Tunnel 16 may terminate to form a floor and at least a portion of the space provided by the bulkhead can form a portion of this floor. This concrete capped bulkhead may be utilized to store excess fluid and/or provide space for maintenance for tank 60, for example.

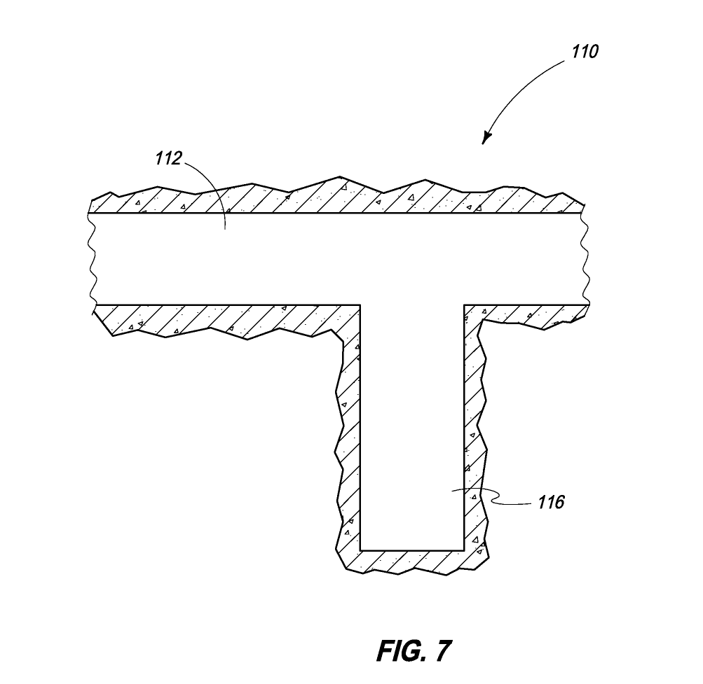

Referring to FIG. 7, an alternative embodiment and configuration is shown as 110. Configuration 110 can include a subterranean room 112 with a tunnel 116 therebelow. In accordance with example implementations, this configuration does not require a tunnel directly above tunnel 116, but a tunnel may exist there as well to facilitate the maintenance of tunnel 116 therebelow. Therefore, according to some implementations of the current disclosure, tunnel 116 may be utilized with no tunnel thereabove or with at least all or a portion of a tunnel thereabove.

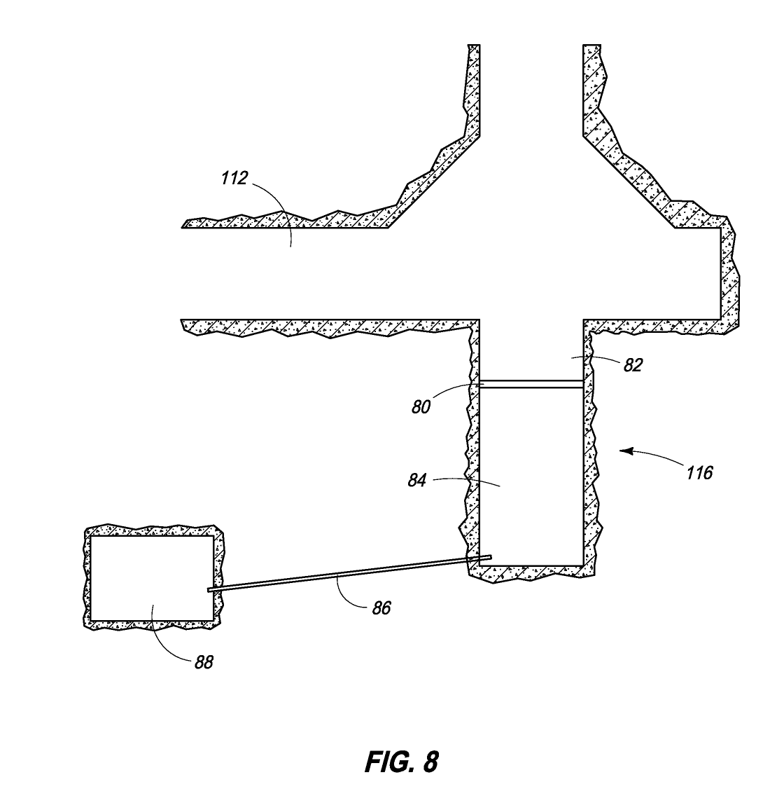

Referring next to FIG. 8, an example implementation of configuration 110 is shown that demonstrates a tunnel 116 terminating to form a floor and a cap 80 extending between the sidewalls of tunnel 116 to form a space 84 therein. According to example configurations, cap 80 can reside about a 10 inches lower than the floor of room 112 and may be constructed of steel or concrete. Space 84 can act as a fluid storage assembly, for example, a fluid storage oversink within tunnel 116. In accordance with example implementations, a hole or space 82 is established between cap 80 and the floor of subterranean room 112 and a tank or space 84 is established between the remaining perimeter of tunnel 116 and cap 80. In accordance with example implementations, the depth of space 82 can be as much as 10 inches while the height of cap 80 in relation to the floor of tunnel 116 can be as high as 20 feet.

In accordance with example implementations, a conduit 86, such as a dram hole or pipe can extend from space 84 to opening 88. Opening 88 can house a pump station which can be utilized to facilitate the transfer of fluid from within tank 84.

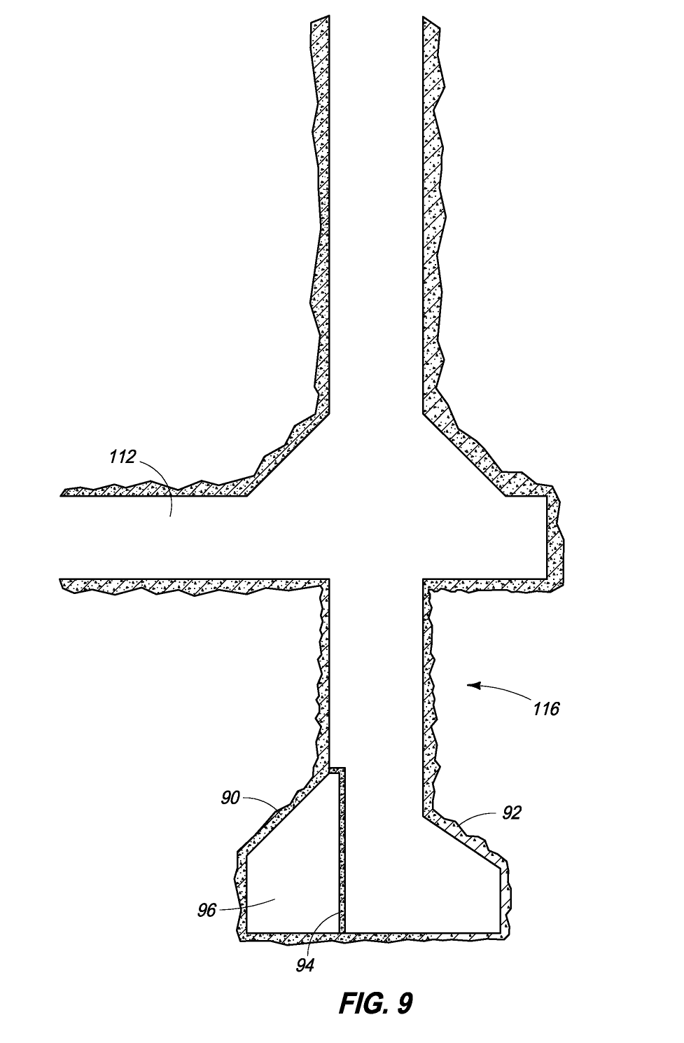

Referring next to FIG. 9, an alternative configuration that includes tunnel 116 below subterranean room 112 is shown. In accordance with example implementations, this configuration includes a twin bulkhead design wherein one perimeter of tunnel 116 can have a bulkhead 90 established thereto, and opposing bulkhead 92 can be established on the opposing perimeter of tunnel 116. In accordance with example implementations, a partition 94 can be established in relation to one of the bulkheads such as bulkhead 90, for example, to form space 96. This partition can be constructed of concrete for example and partition space 96 from the remainder of tunnel 116. In accordance with example implementations, this can establish a fluid storage tank 96 within tunnel 116.

In accordance with the above, methods for providing and/or removing fluid storage from a subterranean petroleum mining configuration are provided. The methods can include providing one or more fluid storage tanks. These storage tanks can be provided in a series or as one large tank as described, for example.

The methods can further include conveying the one or more fluid storage tanks in a continuous vertical direction between the terrain above the configuration to a tunnel below a subterranean room of the configuration. These rooms and/or tunnels and spaces can be lined with concrete, for example.

In compliance with the statute, embodiments of the invention have been described in language more or less specific as to structural and methodical features. It is to be understood, however, that the entire invention is not limited to the specific features and/or embodiments shown and/or described, since the disclosed embodiments comprise forms of putting the invention into effect. The invention is, therefore, claimed in any of its forms or modifications within the proper scope of the appended claims appropriately interpreted in accordance with the doctrine of equivalents.

1. A subterranean tunnel and storage configuration comprising:
a first vertical tunnel extending from the terrain and through the earth below;
a subterranean room connecting with the first vertical tunnel;
a second vertical tunnel connecting with the room and aligned with the first vertical tunnel; and
a fluid storage assembly below the room and within the vertical tunnel, the assembly comprising one or more fluid storage tanks.

2. The subterranean tunnel and storage configuration of claim 1 further comprising a partition extending horizontally between the walls of the vertical tunnel.

3. The subterranean tunnel and storage configuration of claim 2 wherein the vertical tunnel terminates to form a floor, the partition, walls and floor defining a compartment within the tunnel.

4. The subterranean tunnel and storage configuration of claim 3 further comprising a passageway within the partition.

5. The subterranean tunnel and storage configuration of claim 2 wherein the partition is continuous with the floor of the room.

6. The subterranean tunnel and storage configuration of claim 1 further comprising a plurality of partitions, each individual partition extending between the walls of the tunnel to form a plurality of compartments within the tunnel.

7. The subterranean tunnel and storage configuration of claim 6 wherein two of the partitions and the sidewalls of the tunnel form a compartment within the tunnel.

8. The subterranean tunnel and storage configuration of claim 7 wherein one of the two partitions defines a floor of the compartment and the other of the two partitions defines a ceiling of the compartment, the one or more fluid storage tanks being within the compartment.

9. The subterranean tunnel and storage configuration of claim 8 further comprising a plurality of fluid storage tanks arranged along the sidewalls of the tunnel.

10. The subterranean tunnel and storage configuration of claim 9 further comprising:
passageways within both of the partitions, the passageways being vertically aligned; and
a ladder extending between the passageways.

11. A subterranean tunnel and storage configuration comprising:
a subterranean room within the earth below the terrain;
a vertical tunnel connecting with the subterranean room and extending into the earth below the room; and
a fluid storage assembly within the second vertical tunnel.

12. The subterranean tunnel and storage configuration of claim 11 further comprising a bulkhead extending from the second vertical tunnel.

13. The subterranean tunnel and storage configuration of claim 12 wherein the second tunnel terminates to form a floor, the extended bulkhead forming at least a portion of the floor.

14. The subterranean tunnel and storage configuration of claim 13 further comprising a wall extending vertically and partitioning the bulkhead from the second vertical tunnel to form the fluid storage assembly.

15. The subterranean tunnel and storage configuration of claim 12 wherein the bulkhead extends to one side of the second vertical tunnel and the fluid storage assembly resides in the tunnel opposing the one side.

16. The subterranean tunnel and storage configuration of claim 11 wherein the second vertical tunnel terminates to form a floor, the configuration further comprising a cap extending between the walls of the vertical tunnel to form the fluid storage assembly.

17. The subterranean tunnel and storage configuration of claim 16 further comprising a conduit extending from the fluid storage assembly through the earth to an opening in the earth.

18. A method for providing and/or removing fluid storage from a subterranean petroleum mining configuration, the method comprising:
providing one or more fluid storage tanks; and
conveying the one or more fluid storage tanks in a continuous vertical direction between the terrain above the configuration to a tunnel below a subterranean room of the configuration.

19. The method for providing and/or removing fluid storage from a subterranean petroleum mining configuration of claim 18 further comprising opening a hatch in a passageway of a partition defining a compartment within the tunnel.

20. The method for providing and/or removing fluid storage from a subterranean petroleum mining configuration of claim 19 further comprising placing the one or more fluid storage tanks along the sidewall of the tunnel.
